(19) United States
(12) Patent Application Publication
(10) Pub. No.: US 2005/0194800 A1
(43) Pub. Date: Sep. 8, 2005

(54) Apparatus for carrying crates

(76) Inventor: Robert J. Delaney, Placentia, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/795,100

(22) Filed: Mar. 5, 2004

(51) Int. Cl. B65G 7/12

(52) U.S. Cl. 294/16

(57) ABSTRACT

In one aspect, the invention provides an apparatus for carrying crates of varying sizes. The apparatus comprises a first elongate member having a handle portion at each end thereof, and a bearing portion disposed between the handle portions, the bearing portion is adapted to engage a first portion of a sidewall of the crate. The apparatus further comprises a second elongate member having a handle portion at each end thereof and a bearing portion disposed between the handle portions. The bearing portion of the second elongate member is adapted to engage a second portion of a sidewall of the crate opposite the first portion. The apparatus further comprises first and second cross brace members adapted to be connected to the first and second elongate members and to thereby engage third and fourth portions of a sidewall of the crate.

### BACKGROUND OF THE INVENTION

1. Field of the Invention

The invention relates to an apparatus to carry objects, and particularly an apparatus to carry crates containing trees, plants and the like.

2. Description of the Related Art

Planting crates are often transported by vehicles, such as forklifts, cranes, etc. In such circumstances one or more chains may be wrapped around the crate and the vehicle then lifts the crate by the chain. In many circumstances, however, it is not feasible to use a mechanized vehicle. For example, the crate containing plants, trees, etc. may need to be transported over uneven terrain, or garden walls, and the like. In some circumstances, there may not be a sufficiently large passageway for the vehicle. Furthermore, depending upon the size of the project, the use of forklifts or cranes may be too costly.

Planting crates are also commonly transported by hand. For example, individuals may grasp the metal bands of the crate and physically move the crate. This is often difficult, particularly for larger crates. Grasping the metal bands also can be dangerous because it requires personnel to be nearly against the crate. If the band snaps, the crate would fall and potentially injure the foot of an individual carrying the crate. When planting crates are carried by hand, it is also difficult to locate the crate directly over the hole in which the plant is to be planted. Thus, the crates are sometimes slid into the hole which results in the crate being tipped, which could damage the plant.

Accordingly, there exists a need for a cost-effective apparatus for use in carrying planting crates and the like over a wide variety of terrains in a manner which is easier and safer than currently employed.

### SUMMARY OF THE INVENTION

In one aspect, the invention provides an apparatus for carrying crates of varying sizes. The apparatus comprises a first elongate member having a handle portion at each end thereof, and a bearing portion disposed between the handle portions, the bearing portion is adapted to engage a first portion of a sidewall of the crate. The apparatus further comprises a second elongate member having a handle portion at each end thereof and a bearing portion disposed between the handle portions. The bearing portion of the second elongate member is adapted to engage a second portion of a sidewall of the crate opposite the first portion. The apparatus further comprises first and second cross brace members adapted to be connected to the first and second elongate members and to thereby engage third and fourth portions of a sidewall of the crate.

In another aspect, the invention provides an apparatus comprising a first elongate member having a handle portion at each end thereof, and a bearing portion disposed between the handle portions. The bearing portion has a planar surface adapted to engage a first wall of the crate to be carried. The apparatus further comprises a second elongate member having a handle portion at each end thereof and a bearing portion disposed between the handle portions. The bearing portion has a planar surface adapted to engage a second wall of the crate opposite the first wall. The apparatus further comprises a first cross brace member adapted to be connected to the first and second elongate members and to thereby engage a third wall of the crate, and a second cross brace member adapted to be connected to the first and second elongate members and thereby engage a fourth wall of the crate.

In another aspect, the invention provides an apparatus comprising a first bar having a length greater than a first sidewall of the crate to be carried so as to provide handles to be gripped by one or more users at each end of the first bar and a second bar having a length greater than a second sidewall of the crate to be carried so as to provide handles to be gripped by one or more users at each end of the second bar. The apparatus further comprises a first bearing member having a surface adapted to engage the first sidewall of the crate and means for removably connecting the bearing member to the first bar between the handles of the first bar, and a second bearing member having a surface adapted to engage the second sidewall of the crate and means for removably connecting the bearing member to the second bar between the handles of the second bar. The apparatus further comprises first and second cross brace members adapted to be connected to the first and second bearing members and to thereby engage third and fourth sidewalls of the crate, the first and second cross brace members each comprising a flexible portion and a plurality of clips.

In another aspect, the invention provides an apparatus for lifting a crate, which comprises first and second rigid elongate members adapted to be disposed along first and second side walls of the crate. The elongate members have a length sufficient to extend beyond the edges of the first and second sidewalls of the crate, each end of the elongate members comprises a handle to be held by a user. The apparatus further comprises first and second flexible cross braces adapted to be connected to the first and second elongate members and to be disposed along third and fourth sidewalls of the crate.

In another aspect, the invention provides an apparatus adapted to engage first and second elongate shafts for carrying crates of varying sizes. The apparatus comprises a first bearing member having a surface adapted to engage a first sidewall of the crate and having means for removably connecting the bearing member to a first elongate shaft, the bearing member having a plurality of connecting points extending in a generally linear arrangement. The apparatus further comprises a second bearing member having a surface adapted to engage a second sidewall of the crate and having means for removably connecting the bearing member to a second elongate handle, the bearing member having a plurality of connecting points extending in a generally linear arrangement. The apparatus further comprises first and second cross brace members adapted to be connected to the first and second bearing members and to thereby engage third and fourth sidewalls of the crate, the cross brace members comprising a flexible portion and a plurality of clips for removably connecting the second cross brace member to the first and second bearing members.

### BRIEF DESCRIPTION OF THE DRAWINGS

FIG. 1 is a perspective view of an apparatus for carrying planting crates in accordance with the present invention.

FIG. 2 is a perspective view of a clip used with a cross brace member of the present invention.

FIG. 3 is a cross-sectional view of an apparatus engaging a planting crate in accordance with the present invention.

FIG. 4 is a perspective view of an embodiment of an elongate member.

FIG. 5 is a cross-sectional view taken along the line 5-5 of FIG. 4.

FIG. 6 is an exploded perspective view of the elongate member of FIG. 4.

FIG. 7 is a perspective view illustrating an apparatus of the present invention.

FIG. 8a is an exploded perspective view of a bearing member of the present invention and a garden tool to be used therewith.

FIG. 8b is a perspective view of a bearing member engaging a garden tool.

FIG. 9 is a perspective view of an apparatus for carrying crates in accordance with the present invention which is adapted to be used with a pair of garden tools.

FIG. 10 is a perspective view illustrating the use of the apparatus of the present invention to carry a large planting crate by four persons.

FIG. 11 is a perspective view illustrating the use of the apparatus of the present invention to carry a small planting crate by two persons.

### DETAILED DESCRIPTION OF THE PREFERRED EMBODIMENT

The following detailed description is of the presently preferred embodiments for carrying out the invention. This description is not to be taken in a limiting sense; it is merely for the purpose of illustrating the principles of the invention as embodied in certain preferred embodiments. The scope of the invention is best defined by the appended claims.

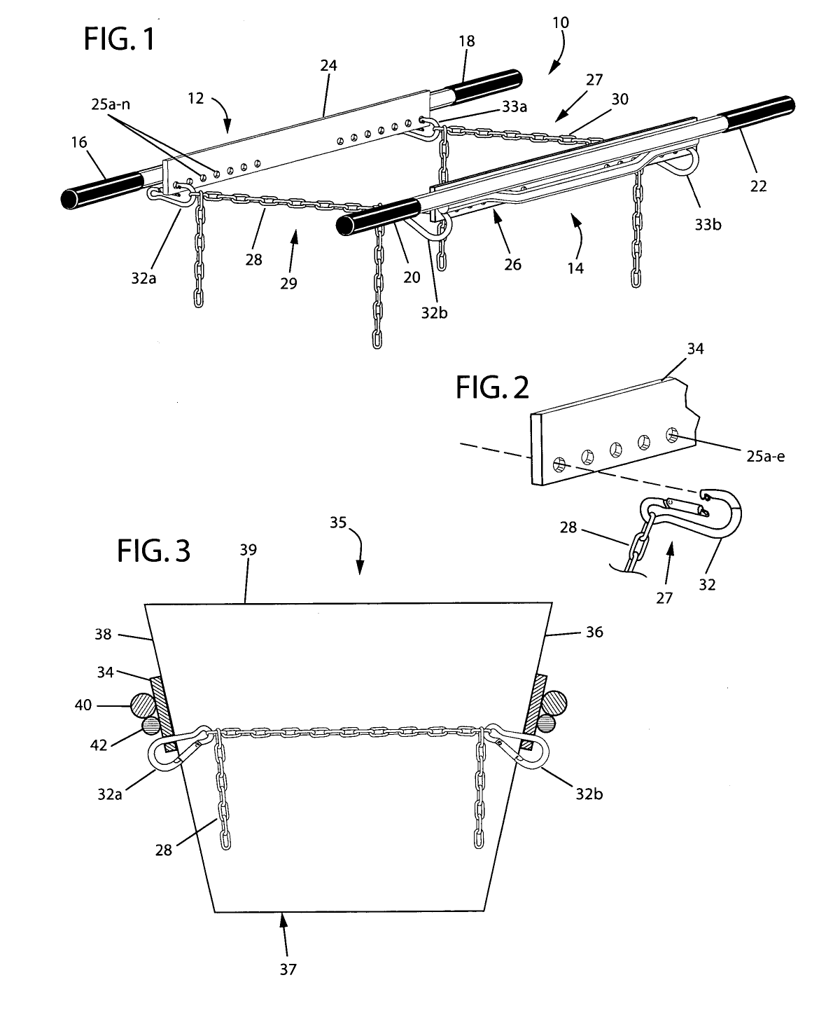

FIG. 1 is a perspective view of an apparatus 10 for carrying planting crates in accordance with the present invention. The apparatus comprises a first elongate member 12 and a second elongate member 14. The elongate members 12, 14 are generally sized to be sufficiently longer than the sidewalls of the crate to be carried. In this manner the elongate members provide for handles at either end of the crate. As shown in FIG. 1, the first elongate member includes handle portions 16, 18 at each end. The second elongate member similarly includes handle portions 20, 22 at each end. The handle portions can include grips of rubber or the like as would be understood by those of skill in the art. The first and second elongate members also include bearing portions 24, 26 disposed between the handle portions.

The elongate members can each be unitary structures, or they can be comprised of multiple components. The elongate members can be made of suitable materials known to those of skill in the art, including steel and aluminum. Steel is generally preferred based upon cost and strength considerations.

A first cross brace member 27 is connected to the first and second elongate members 12, 14. In the preferred embodiment, the cross brace member comprises a chain 28 and clips 32a, b. Similarly, second cross brace member 29 comprises chain 30 and clips 33a, b. The clips allow for removable connection of the cross brace member. The clips illustrated in the embodiment of FIG. 1 are carbiner-type. Other types of clips are also suitable, including S-shaped clips and the like. Alternatively, the links of chain 28 could also be connected to a hook on the elongate member without need for a clip. Alternatively, the cross brace members can be fixably connected to either or both elongate members. As one of skill would appreciate, however, removable connection provides flexibility in allowing for a single apparatus to fit crates of varying size. Removable connection is particularly preferred for at least one of the cross brace member/elongate member connections to allow the apparatus to be connected around a crate resting on the ground.

FIG. 2 is a perspective view of a clip 32 of first cross brace member 27 of the present invention. Bearing portions 24, 26 of elongate members 12,14 include multiple points for connection with the cross brace member. The connection points are spaced so as to allow the apparatus to engage crates of various size. Preferably, the connection points are spaced to accommodate typical crates from about 16 inches square to about three feet square. Generally sizes up to about two feet square can be carried by two individuals, and larger sizes up to about three feet square may be carried by four or more individuals. In a preferred embodiment, the connection points comprise holes 25a-e. As one of skill would appreciate, various types of connectors could also be used. Clip 32 of cross brace member 27 allows for a removable connection to any of the various connection points.

FIG. 3 is a cross-sectional view of an apparatus of the present invention engaging a planting crate 35. A typical planting crate is comprised of four sidewalls and a base. One or more metal bands are wrapped around the sidewalls. A typical planting crate 35 is constructed such that opening 39 has a larger area than base 37, thereby resulting in a trapezoidal cross-section as illustrated in FIG. 3. This allows the apparatus of the present invention to engage sidewalls 38, 36 of the planting crate after the apparatus is assembled on the ground and then lifted. The apparatus can be sized to engage the crate at various points along the sidewall. Generally, it would be preferable to engage the sidewall at or slightly above the center of gravity of the crate for best stability. The ability to size the apparatus to engage the crates at varying positions enables users to carry the crate at a desired elevation off the ground. For example, users may desire to size the apparatus to provide a comfortable carrying position, e.g. with users' arms fully extended at their sides. In some circumstances, a user may choose to engage the crate at a lower position along the sidewall of the crate to make it easier to carry the crate over obstacles such as small garden walls and the like.

As one of skill could appreciate, the apparatus of the present invention could also be used with crates of varying shapes and construction. If the crate does not have the typical trapezoidal configuration referenced above, the crate preferably will have a lip or some structure or shape to engage the bearing portions of the elongate members as the apparatus is lifted. In such cases, however, the ability to position the apparatus at various points along the sidewall of the crate would be limited.

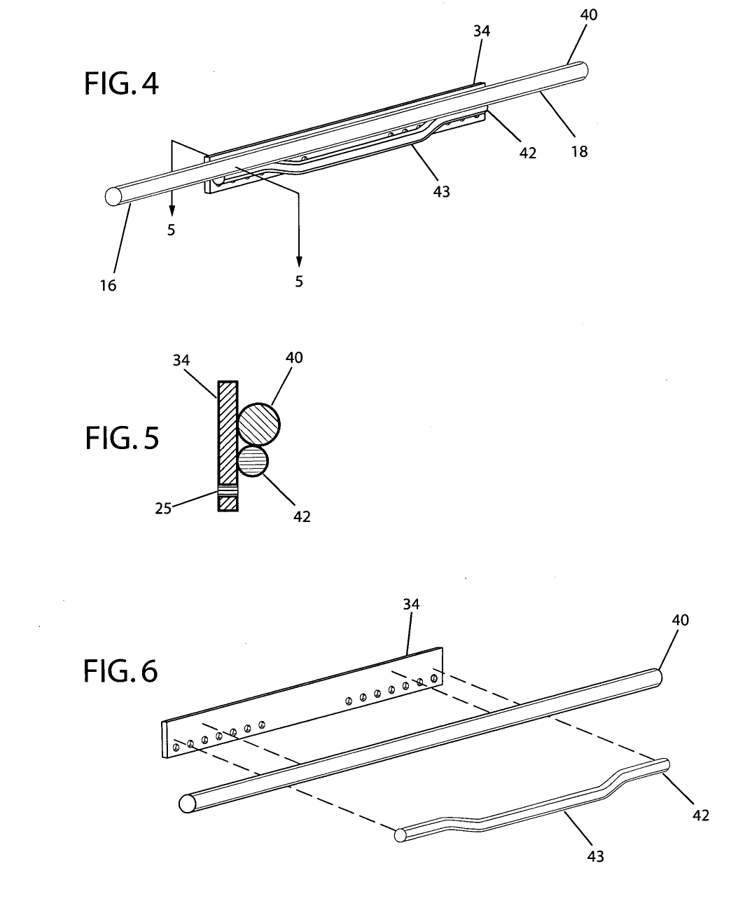

FIG. 4 is a perspective view of an elongate member of a preferred embodiment of the present invention. FIG. 6 is an exploded perspective view of the elements forming the preferred elongate member of FIG. 4. The elongate member includes bar or rod 40, which is sized so as to extend beyond either end of a crate to be carried, thereby providing handle portions 16, 18. The bearing portion of the elongate member includes planar member 34, which is connected to rod 40 by any suitable means. Support bar 42 is also connected to planar member 34 and rod 40. Support bar 42 may also be shaped so as to provide a side handle 43. Alternatively, rod 40 could also be shaped to provide a handle.

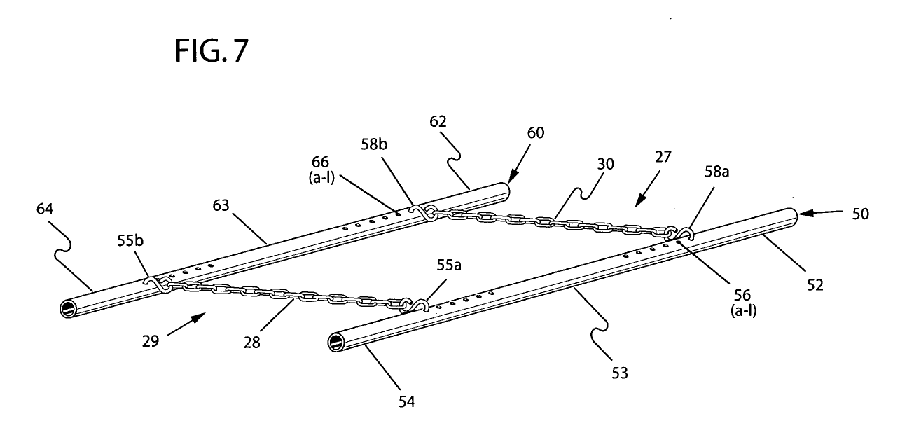

FIG. 7 illustrates a perspective view of another preferred embodiment of the present invention wherein the first and second elongate members comprise a unitary structure, namely rods or bars 50, 60. The portion of rods 50, 60 disposed between the handles comprises the bearing portion of the elongate members. The elongate members include connection points for connecting a plurality of cross braces. Illustrated in FIG. 7 are holes 56a-1 for first elongate member 50 and holes 66a-1 for second elongate member 60. The first elongate member 50 includes a bearing portion 53 disposed between handle portions 52, 54. Second elongate member 60 includes bearing portion 63 disposed between handle portions 62, 64. The elongate members are sized so as to extend beyond the sides of a crate to be carried and provide handle portions 52, 54 for first elongate member 50 and handle portions 62, 64 for second elongate member 60.

As shown in FIG. 7, the first cross brace member 27 includes chain 30 and connectors 58a, b. Any suitable connectors may be used to fixably or removably connect the first cross brace member 27 to first and second elongate members 50, 60. Illustrated in FIG. 7 are S-shaped hooks to engage the holes of the elongate members. Second cross brace member 29 similarly includes a chain 28 and connectors 55a, b. As described above, the holes of the elongate members could also be replaced with hooks to directly engage the links of chains 28, 30.

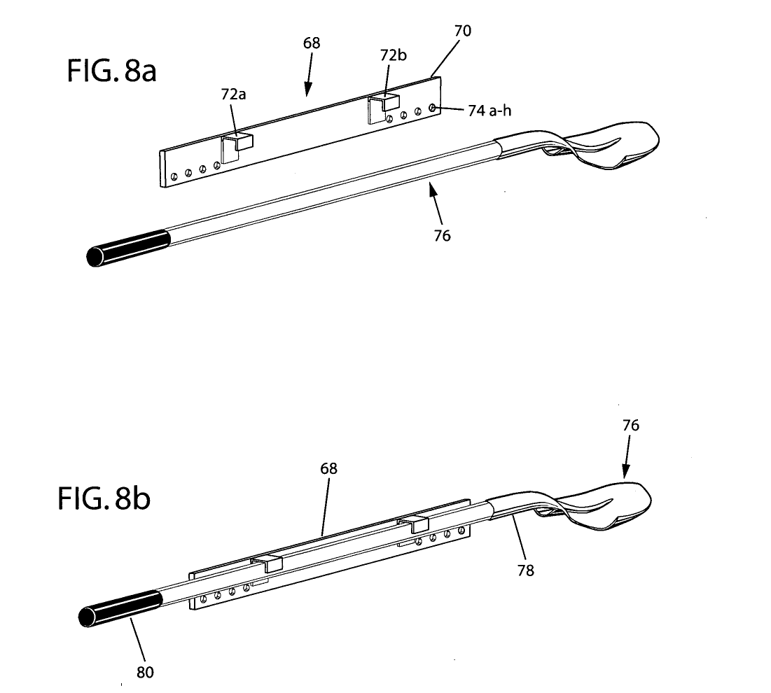

FIG. 8a illustrates an exploded perspective view of a further embodiment of the present invention, namely, a bearing member adapted to be used with an elongate shaft of a garden tool, or the like. This embodiment of the invention allows a landscaper to use the apparatus in conjunction with readily available tools. FIG. 8b provides a perspective view of the bearing member engaging a shaft of a garden tool. In this embodiment, the overall size of the apparatus is minimized by allowing the landscaper to utilize readily available garden tools to facilitate the moving of crates of various sizes.

Bearing member 68 comprises a bearing structure 70 to engage a sidewall of a crate to be carried. In a preferred embodiment, bearing structure 70 has a planar surface to engage the planar sidewall of the crate to be carried. So as to accommodate crates of varying sizes, bearing structure 70 includes connecting points at various locations to allow for connection to a plurality of cross brace members. The preferred connecting points shown in the embodiment of FIG. 8 comprise hole 74a-h, although a variety of connections known to those of skill in the art would also be suitable. The bearing member further includes means for removably engaging the bearing member with an elongate element such as the handle for garden tool 76. In particular, clips 72a, b extend over and engage the handle of garden tool 76. Bearing member 68 is sized such that garden tool 76 extends beyond its ends to allow for handle portions 78, 80.

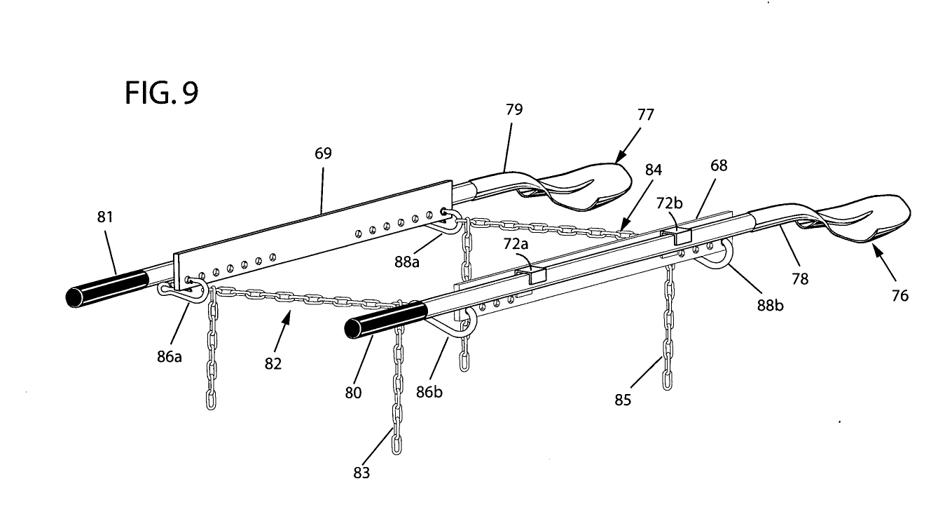

FIG. 9 is a perspective view of the apparatus of FIG. 8. As illustrated, the apparatus is adapted for use with a pair of garden tools. The apparatus comprises bearing members 68, 69. As shown with respect to bearing member 68, hooks 72a, b are provided to engage the handle of garden tool 76. Hooks 72a, b extend over the handle of tool 76. The elongate handle of garden tool 76 thereby forms handle portions 78, 80 to allow a use to lift the apparatus. Similarly, bearing member 69 is adapted to be use with garden tool 77, which provides handle portions 79, 81.

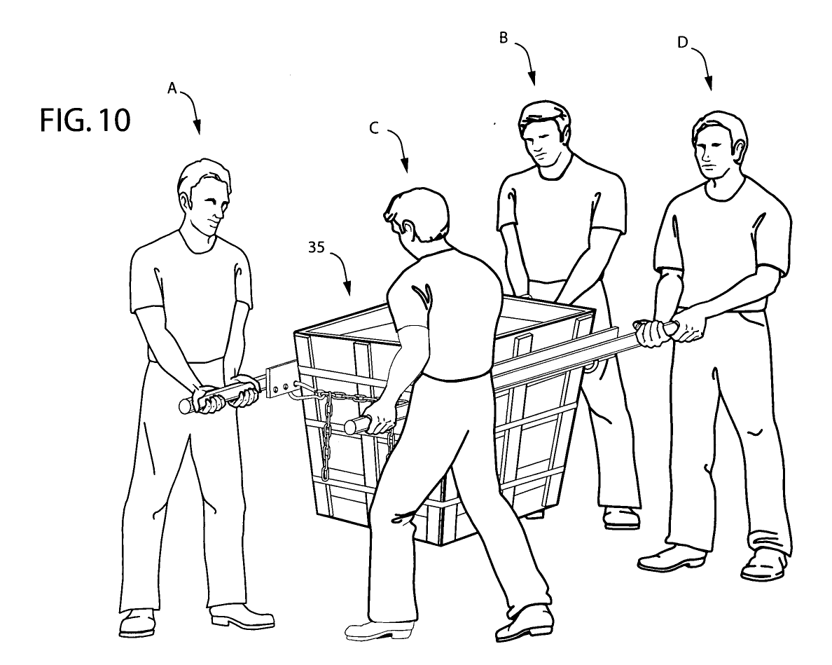

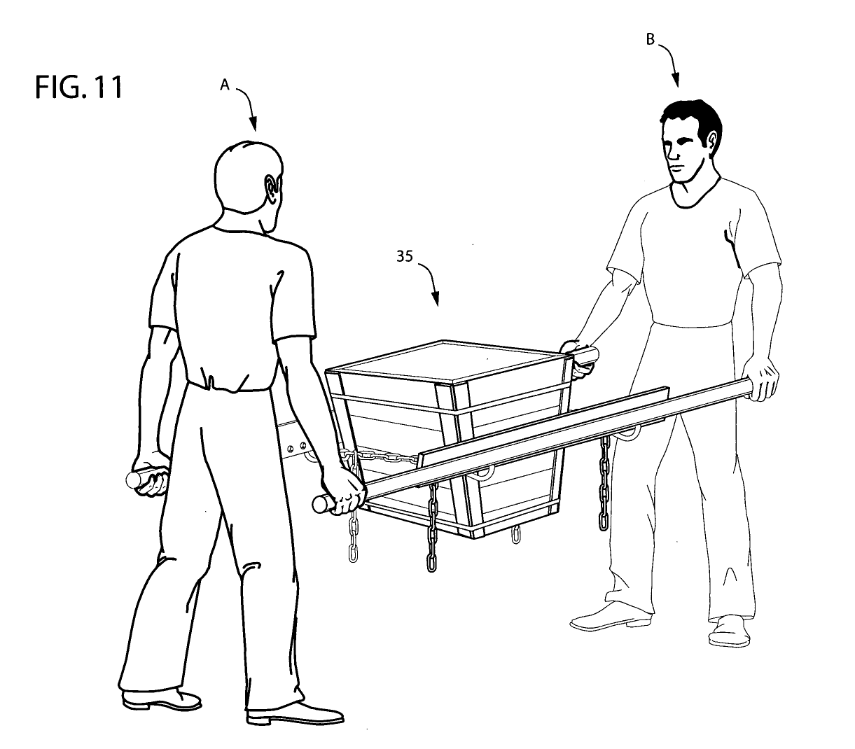

FIG. 10 is a perspective view illustrating the use of the apparatus of the present invention to carry a large planting crate by four persons. The crate 35 comprises four side walls. First and second elongate members engage opposite sidewalls of the crate. First and second cross braces engage the other two sidewalls of the crate. Users A, B, C and D each lift the crate using a handle of the elongate members. In FIG. 11, users A and B carry a crate of smaller sizes. Before lifting the crate, the various elements can be connected together on the ground. The size of the cross brace members and the connecting points chosen to accommodate the particular size and shape of the crate to be carried. The apparatus could also be used to carry multiple crates at once.

It should be noted that the apparatus of the present invention is particularly useful for carrying planting crates, but can also be used for carrying a variety of objects and containers. In keeping with the invention the apparatus described above can also be modified in a variety of ways as may be suitable for specific applications. The scope of the invention is intended to be defined by reference to the appended claims.

1. An apparatus for carrying crates of varying sizes, said apparatus comprising:
a first elongate member having a handle portion at each end thereof, and a bearing portion disposed between said handle portions, said bearing portion adapted to engage a first portion of a side wall of said crate, said first elongate member having a plurality of connection points for removable connection with a plurality of cross brace members,
a second elongate member having a handle portion at each end thereof and a bearing portion disposed between said handle portions, said bearing portion adapted to engage a second portion of a side wall of said crate opposite said first portion,
a first flexible cross brace member adapted to be connected to said first and second elongate members and to thereby engage a third portion of a side wall of said crate, and
a second flexible cross brace member adapted to be connected to said first and second elongate members and thereby engage a fourth portion of a side wall of said crate opposite said third portion.

2. The apparatus of claim 1, wherein said connection points comprise a plurality of holes disposed in a linear arrangement.

3. The apparatus of claim 2, wherein said holes are spaced so as to allow said apparatus to carry planting crates varying in size from about sixteen inches square to about three feet square.

4. The apparatus of claim 3, wherein said first cross brace member comprises a chain.

5. The apparatus of claim 4, wherein said first cross brace member further comprises a clip for removably connecting the chain to the holes in said first elongate member.

6. The apparatus of claim 1, wherein the bearing portion of the first and second elongate members comprise a planar member adapted to be adjacent said crate to be carried.

7. The apparatus of claim 6, wherein said connection points comprise a plurality of holes in said planar member.

8. The apparatus of claim 7, wherein said holes are spaced so as to allow said apparatus to carry planting crates varying in size from about sixteen inches square to about three feet square.

9. An apparatus for carrying plants contained in crates of varying sizes, wherein said crates comprise a base and four walls, the top edge of said four walls defining an opening, the opening having a surface area larger than the base such that the cross-section of the crate is trapezoidal, said apparatus comprising:
a first elongate member having a handle portion at each end thereof, and a bearing portion disposed between said handle portions, said bearing portion having a surface adapted to engage a first wall of said crate, said first elongate member having a plurality of connection points for removable connection with a plurality of cross brace members,
a second elongate member having a handle portion at each end thereof and a bearing portion disposed between said handle portions, said bearing portion having a surface adapted to engage a second wall of said crate opposite said first wall,
a first cross brace member adapted to be connected to said first and second elongate members and to thereby engage a third wall of said crate, and
a second cross brace member adapted to be connected to said first and second elongate members and thereby engage a fourth wall of said crate.

10. An apparatus for carrying plants contained in crates of varying sizes, wherein said crates comprise a base and four sidewalls, the top edge of said four sidewalls defining an opening, the opening having a surface area larger than the base such that the cross-section of the crate is trapezoidal, said apparatus comprising:
a first bar having a length greater than a first sidewall of the crate to be carried so as to provide handles to be gripped by one or more users at each end of said first bar;
a second bar having a length greater than a second sidewall of the crate to be carried so as to provide handles to be gripped by one or more users at each end of said second bar;
a first bearing member having a surface adapted to engage the first sidewall of said crate and means for removably connecting the bearing member to said first bar between the handles of said first bar, said member having a plurality of connecting points extending in a generally linear arrangement;
a second bearing member having a surface adapted to engage the second sidewall of said crate and means for removably connecting the bearing member to said second bar between the handles of said second bar, said bearing member having a plurality of connecting points extending in a generally linear arrangement;
a first cross brace member adapted to be connected to said first and second bearing members and to thereby engage a third sidewall of said crate, said cross brace member comprising a flexible portion and a plurality of clips, and
a second cross brace member adapted to be connected to said first and second elongate members and thereby engage a fourth side wall of said crate, said cross brace member comprising a flexible portion and a plurality of clips for removably connecting said second cross brace member to said first and second bearing members.

11. The apparatus of claim 10, wherein said first bearing member further comprises a hook which extends over said first bar to removably connect the bearing member to the first bar.

12. The apparatus of claim 11, wherein said first bar comprises an elongate handle of a garden tool.

13. An apparatus for carrying plants contained in crates of varying sizes, wherein said crates comprise a base and four sidewalls, said apparatus comprising:
a first rigid elongate member adapted to be disposed along a first side of the crate, said elongate member having a length sufficient to extend beyond the edges of a first sidewall of said crate, each end of said elongate member comprising a handle to be held by a user,
a second rigid elongate member adapted to be disposed along a second side of the crate, said elongate member having a length sufficient to extend beyond the edges of a second sidewall of said crate, each end of said elongate member comprising a handle to be held by a user,
a first flexible cross brace adapted to be connected to said first and second elongate members and to become taut when said crate is lifted and to be disposed along a third sidewall of the crate; and
a second flexible cross brace adapted to be connected to said first and second elongate members and to become taut when said crate is lifted and to be disposed along a fourth sidewall of the crate.

14. The apparatus of claim 13, wherein said first elongate member comprises a planar surface located between said handles, said planar surface adapted to be adjacent the first side wall of the crate to be lifted.

15. The apparatus of claim 14, wherein said planar surface has a purality of connection points to be connected with first and second cross braces.

16. The apparatus of claim 15, wherein said connection points comprise holes adapted to engage a clip from each of the first and second cross braces.

17. The apparatus of claim 16, wherein said first and second cross brace each comprise a chain.

18. An apparatus adapted to engage first and second elongate shafts to carry crates of varying sizes, said apparatus comprising:
a first bearing member having a surface adapted to engage a first sidewall of said crate and having means for removably connecting the bearing member to a first elongate shaft, said bearing member having a plurality of connecting points extending in a generally linear arrangement;
a second bearing member having a surface adapted to engage a second sidewall of said crate and having means for removably connecting the bearing member to a second elongate shaft, said bearing member having a plurality of connecting points extending in a generally linear arrangement;
a first cross brace member adapted to be connected to said first and second bearing members and to thereby engage a third sidewall of said crate, said cross brace member comprising a flexible portion and a plurality of clips, and a second cross brace member adapted to be connected to said first and second elongate members and thereby engage a fourth side wall of said crate, said cross brace member comprising a flexible portion and a plurality of clips for removably connecting said second cross brace member to said first and second bearing members.

19. The apparatus of claim 17 wherein said means for removably connecting each of said bearing members to said elongate shafts comprises a hook adapted to extend over said shafts.
